(19) United States
(12) Patent Application Publication
(10) Pub. No.: US 2010/0174828 A1
(43) Pub. Date: Jul. 8, 2010

(54) METHOD AND SYSTEM FOR OPTIMIZING ROUTING BETWEEN NODES IN PROXY MOBILE IPv6 NETWORK

(75) Inventors: Sangjin Jeong, Daejeon (KR); Hyoung Jun Kim, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/602,220

(22) PCT Filed: Jun. 24, 2008
(86) PCT No.: PCT/KR08/03583

§ 371 Date: Nov. 30, 2009

(30) Foreign Application Priority Data
Jun. 27, 2007 (KR) 10-2007-0063785
Aug. 27, 2007 (KR) 10-2007-0086241
Jun. 11, 2008 (KR) 10-2008-0054665

(51) Int. Cl. G06F 15/173

(52) U.S. Cl. 709/238

(57) ABSTRACT

A method and system for FIG. 2 optimizing a route between nodes in a Proxy Mobile Internet Protocol version 6 (PMIPv6) network is provided. The method of optimizing the route between nodes in the PMIPv6 network includes: performing a home address (HoA) test between a first Mobile Access Gateway (MAG) and a second MAG using an Internet Protocol version 6 (IPv6) home address of a mobile node and an IPv6 address of a correspondent node; performing a care-of address (CoA) test between the first MAG and the second MAG using an IPv6 Proxy CoA of the first MAG and the IPv6 address of the correspondent node; and setting an optimal route between the first MAG and the second MAG based on binding information that is generated by performing the HoA test and the CoA test.

### TECHNICAL FIELD

The present invention relates to a method and system for optimizing a route between nodes in a Proxy Mobile Internet Protocol version 6 (PMIPv6) network.

This work was supported by the IT R&D of MIC and IITA. [2006-S-061-02, R & D on Router Technology for IPv6 based QoS services and Host mobility]

### BACKGROUND ART

A Proxy Mobile Internet Protocol version 6 (PMIPv6) was developed to support network-based mobility in an Internet Protocol version 6 (IPv6) environment. Also, the PMIPv6 is offered to overcome disadvantages in a method of providing host-based mobility such as a conventional mobile IPv6.

In a method of supporting mobility of a host based on PMIPv6, data exchange between hosts must be performed via a Local Mobility Anchor (LMA) in a network. Therefore, triangular routing where data is inefficiently transferred may occur.

In particular, when a PMIP domain providing a PMIPv6-based mobility is enlarged, a great amount of data may be concentrated on a single LMA. In this case, Quality of Service (QoS) for user data may not be guaranteed. Also, data exchange between neighboring nodes is performed via the LMA. Therefore, long latency times may occur when transferring data.

### DISCLOSURE OF INVENTION

### Technical Goals

An aspect of the present invention provides a method and system that can provide an optimal route between a mobile node and a correspondent node through Internet Protocol (IP) tunneling between Mobile Access Gateways (MAGs) using a home address of the mobile node and a Proxy Care-of Address (Proxy CoA) of an MAG.

Another aspect of the present invention also provides a method and system that can provide an optimal route with respect to an Internet Protocol version 4 (IPv4) support node and an IPv6 support node in a Proxy Mobile Internet Protocol version 6 (PMIPv6) network.

Another aspect of the present invention also provides a method and system that enables data exchange between nodes via an optimal route without a need for using a Local Mobility Anchor (LMA), and thereby can improve data communication efficiency between the nodes.

Another aspect of the present invention also provides a method and system that can prevent a great amount of data from concentrating on a single LMA due to enlargement of a PMIPv6 domain.

Another aspect of the present invention also provides a method and system that can improve Quality of Service (QoS) and also reduce data transmission latency.

The present invention is not limited to the above purposes and other purposes not described herein will be apparent to those of skill in the art from the following description.

### Technical Solutions

According to an aspect of the present invention, there is provided a method of optimizing a route between mobile nodes in a Proxy Mobile Internet Protocol version 6 (PMIPv6) network, the method including: performing a home address (HoA) test between a first Mobile Access Gateway (MAG) and a second MAG using an Internet Protocol version 6 (IPv6) home address of a mobile node and an IPv6 address of a correspondent node; performing a care-of address (CoA) test between the first MAG and the second MAG using an IPv6 Proxy CoA of the first MAG and the IPv6 address of the correspondent node; and setting an optimal route between the first MAG and the second MAG based on binding information that is generated by performing the HoA test and the CoA test.

According to another aspect of the present invention, there is provided a method of optimizing a route between nodes in a PMIPv6 network, the method including: performing an HoA test between a first MAG and a second MAG using an IPv6 Proxy CoA of the first MAG and an IPv6 Proxy CoA of the second MAG; performing a CoA test between the first MAG and the second MAG using the IPv6 Proxy CoA of the first MAG and the IPv6 Proxy CoA of the second MAG; and setting an optimal route between the first MAG and the second MAG based on binding information that is generated by performing the HoA test and the CoA test.

According to still another aspect of the present invention, there is provided a method of optimizing a route between nodes in a PMIPv6 network, the method including: performing an HoA test between a first MAG and a second MAG by using an IPv6 home address of a mobile node and an IPv6 address of a correspondent node, or by using an IPv6 Proxy CoA of the first MAG and an IPv6 Proxy CoA of the second MAG; performing a CoA test between the first MAG and the second MAG by using the IPv6 Proxy CoA of the first MAG and the IPv6 address of the correspondent node, or by using the IPv4 Proxy CoA of the first MAG and the IPv4 Proxy CoA of the second MAG; and setting an optimal route between the first MAG and the second MAG based on binding information that is generated by performing the HoA test and the CoA test.

According to yet another aspect of the present invention, there is provided a system for optimizing a route between nodes in a PMIPv6 network, the system including: an HoA test performing unit to perform an HoA test between a first MAG and a second MAG; a CoA test performing unit to perform a CoA test between the first MAG and the second MAG; and a binding information maintaining unit to set an optimal route between the first MAG and the second MAG based on binding information that is generated by performing the HoA test and the CoA test, wherein the HoA test performing unit performs the HoA test by using at least one of 1) an IPv6 home address of a mobile node and an IPv6 address of a correspondent node, and 2) an IPv4 home address of the mobile node and an IPv4 address of the correspondent node, and the CoA test performing unit performs the CoA test by using at least one of 1) the IPv6 Proxy CoA of the first MAG and the IPv6 address of the correspondent node, and 2) an IPv4 Proxy CoA of the first MAG and the IPv4 address of the correspondent node.

Additional aspects, features, and/or advantages of the invention will be set forth in part in the description which follows and, in part, will be apparent from the description, or may be learned by practice of the invention.

### ADVANTAGEOUS EFFECT

According to the present invention, it is possible to provide an optimal route between a mobile node and a correspondent node through IP tunneling between Mobile Access Gateways (MAGs) using a home address of the mobile node and a Proxy Care-of Address (Proxy CoA) of an MAG.

Also, according to the present invention, it is possible to provide an optimal route with respect to an Internet Protocol version 4 (IPv4) support node and an IPv6 support node in a Proxy Mobile Internet Protocol version 6 (PMIPv6) network.

Also, according to the present invention, it is possible to enable data exchange between nodes via an optimal route without a need for using a Local Mobility Anchor (LMA), and thereby improve data communication efficiency between the nodes.

Also, according to the present invention, it is possible to prevent a great amount of data from concentrating on a single LMA due to enlargement of a PMIPv6 domain.

Also, according to the present invention, it is possible to improve Quality of Service (QoS) and also reduce data transmission latency.

### BRIEF DESCRIPTION OF DRAWINGS

FIG. 1 illustrates a concept of a method of optimizing a route between nodes in a Proxy Mobile Internet Protocol version 6 (PMIPv6) network according to an exemplary embodiment of the present invention;

FIG. 2 is a flowchart illustrating a method of optimizing a route between nodes in a PMIPv6 network according to an exemplary embodiment of the present invention;

FIG. 3 illustrates an example of transferring a route optimization management message according to an exemplary embodiment of the present invention;

FIG. 4 illustrates an example of a Proxy Home Test Init (HoTI) message according to an exemplary embodiment of the present invention;

FIG. 5 illustrates an example of a Proxy Home Test (HoT) message according to an exemplary embodiment of the present invention;

FIG. 6 illustrates an example of a Proxy Care-of Test Init (CoTI) message according to an exemplary embodiment of the present invention;

FIG. 7 illustrates an example of a Proxy Care-of Test (CoT) message according to an exemplary embodiment of the present invention; and

FIG. 8 is a block diagram illustrating a system for optimizing a route between nodes in a PMIPv6 network according to an exemplary embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

A method of optimizing a route between nodes in a Proxy Mobile Internet Protocol version 6 (PMIPv6) network according to the present invention extends a route optimization scheme of a conventional Mobile Internet Protocol version 6 (MIPv6) technology, and thereby enables exchanging of a route optimization message between a mobile node (MN) and a correspondent node (CN) based on a home address of the MN and a Proxy care-of address (CoA) of a Mobile Access Gateway (MAG). The MAG manages the MN. Therefore, a binding cache is maintained between the MN and the CN that transmit and receive the route optimization message. The binding cache includes mapping information about the home address of the MN and the Proxy CoA of the MAG Accordingly, the MN may directly transfer data, without passing through an existing Local Mobility Anchor (LMA), to the CN through IP tunneling between MAGs.

As described, the method of optimizing the route between nodes in the PMIPv6 network according to the present invention may transfer data between the MN and the CN via an optimal route. The MN and CN c an be either IPv6 node or IPv4 node.

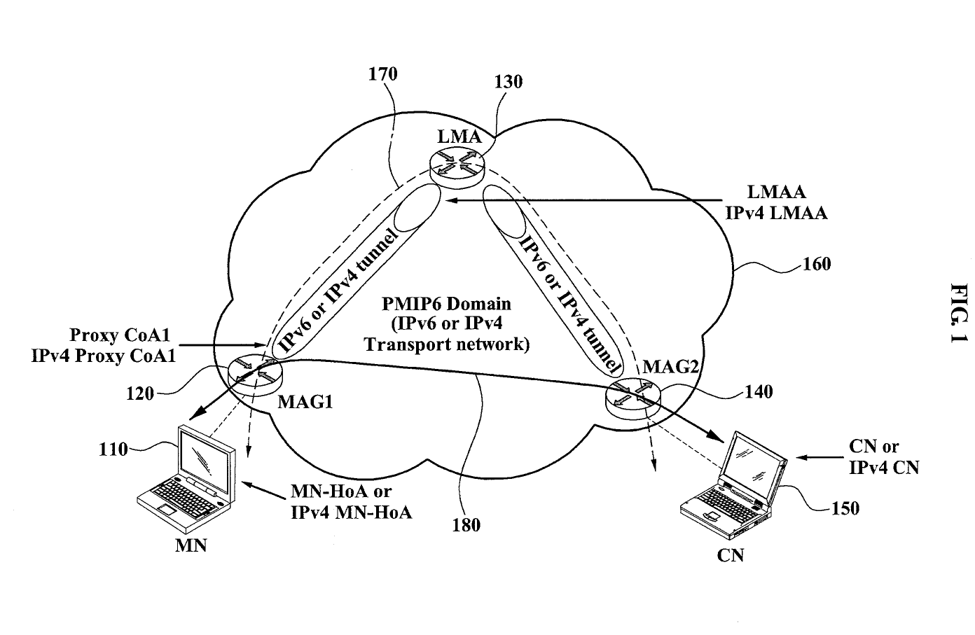

FIG. 1 illustrates a concept of a method of optimizing a route between nodes in a PMIPv6 network according to an exemplary embodiment of the present invention. The method may be performed by a route optimization system. The route optimization system may include an MN 110, a first MAG (MAG1) 120, an LMA 130, a second MAG (MAG2) 140, and a CN 150.

As shown in FIG. 1, when an IPv4 node and an IPv6 node coexist in a PMIPv6 domain 160 that introduces a PMIPv6-based mobility providing protocol, the route optimization system may perform communication between the MN 110 and the CN 150 via an optimal route 180, without performing communication between the MN 110 and the CN 150 via the LMA 130. In this instance, the PMIPv6 domain 160 includes an IPv4 or IPv6 network and may be referred as the PMIPv6 network.

Specifically, the route optimization system enables data exchange between IPv6 nodes or between IPv4 nodes using the optimal route 180 in the PMIPv6-based mobile providing network domain 160. For optimizing the route between the IPv6 nodes, MAG1 and MAG2 may optimize a data exchange route between the MN 110 and the CN 150 that support IPv6, using an IPv6 HoA of the MN 110, an IPv6 Proxy CoA of MAG1, an IPv6 address of the CN 150, an IPv6 Proxy CoA of MAG2, and the like.

Also, for optimizing the route between the IPv4 nodes, MAG1 and MAG2 may optimize the data exchange route between the MN 110 and the CN 150 using an IPv4 HoA of the MN 110, an IPv4 Proxy CoA of MAG1, an IPv4 address of the CN 150, an IPv4 Proxy CoA of MAG2, and the like.

Accordingly, the route optimization system may provide an environment capable of exchanging data between IPv6 nodes or between IPv4 nodes, using the optimal route 180, in the PMIPv6 network 160 .

In the present exemplary embodiment, the CN 150 denotes a node that communicates with the MN 110. Therefore, an example of the CN 150 may include a mobile node such as a laptop, and a fixed node such as a desktop computer. MAG1 may be an access router that processes signaling for mobility management of the MN 110 as a proxy of the MN 110. Also, MAG2 may be an access router that processes signaling for mobility management of the CN 150 as a proxy of the CN 150.

Also, the LMA 130 may be a home agent that manages location information of the MN 110 or the CN 150 in the PMIPv6 domain 160.

Also, the route optimization system may enable data exchange between IPv4 nodes, using the optimal route 180, in the PMIPv6 domain 160. For this, as the IPv6 address of the MN 110 and the IPv6 address of the CN 150, the route optimization system includes IPv6 Proxy CoA of MAG1 and IPv6 Proxy CoA of MAG2 in a Proxy Home Test Init (HoTI)/Proxy Home Test (HoT) message and a Proxy Care-of Test Init (CoTI)/Proxy Care-of Test (CoT) message using a mobile option such as an IPv4 MN HAO, an IPv4 Alt CN Address Option, and the like. The IPv4 MN HAO denotes an option to include an IPv4 HoA of the MN 110 in a PMIPv6 message. The IPv4 Alt CN Address Option denotes an option to include an IPv4 address of the CN 150 in the PMIPv6 message.

Accordingly, the route optimization system may enable data exchange between IPv4 terminals, using the optimal route 180, in the PMIPv6 domain 160.

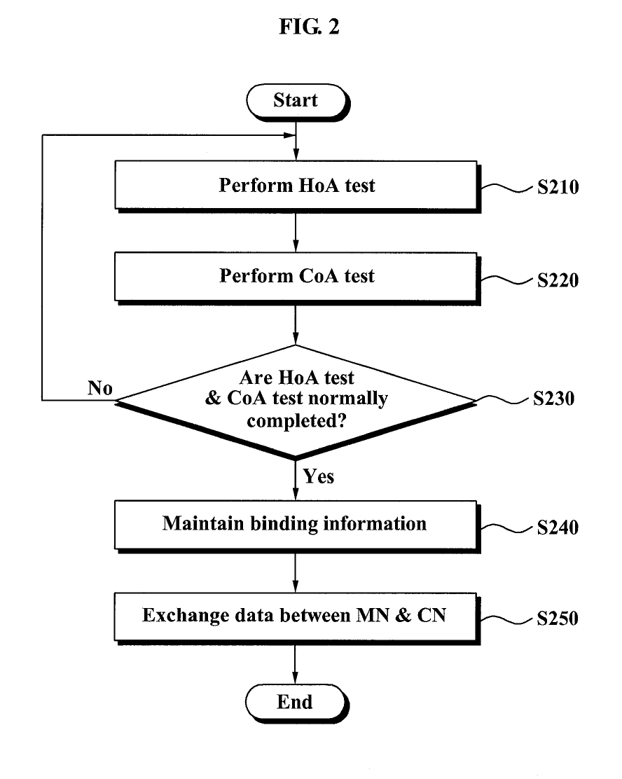

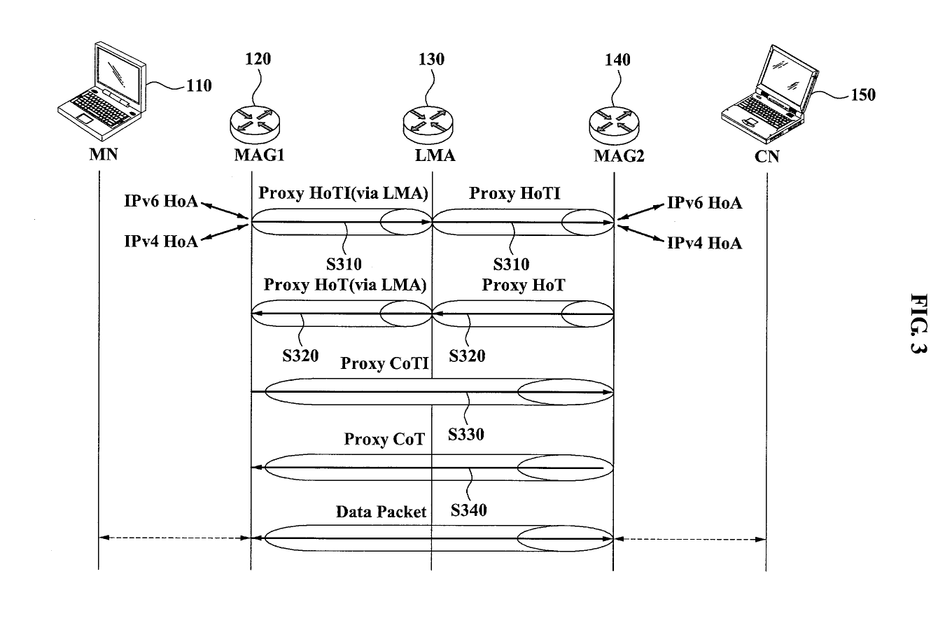

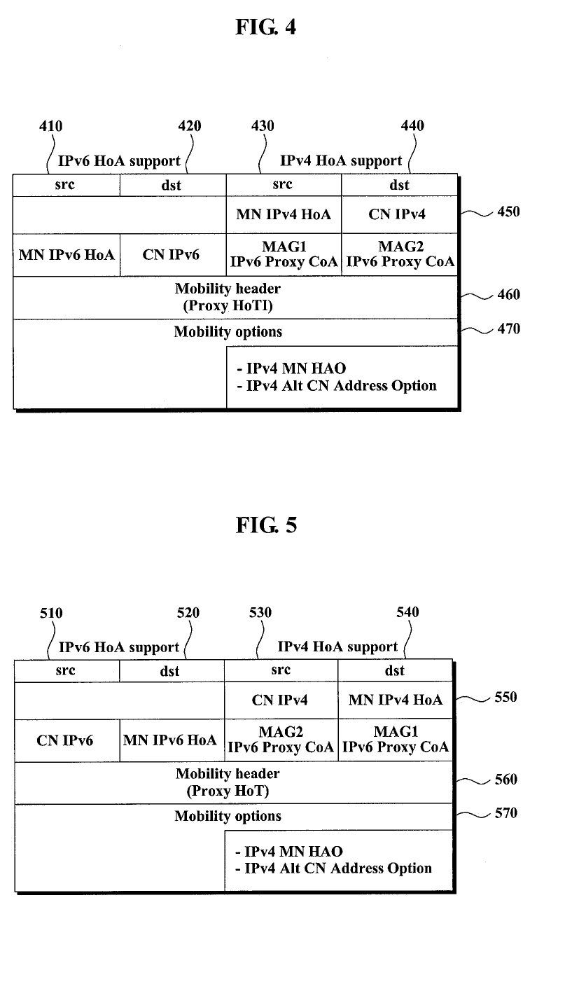

FIG. 2 is a flowchart illustrating a method of optimizing a route between nodes in a PMIPv6 network according to an exemplary embodiment of the present invention, and FIG. 3 illustrates an example of transferring a route optimization management message according to an exemplary embodiment of the present invention. Also, FIGS. 4 through 7 illustrate examples of route optimization management messages according to the present invention.

Referring to FIGS. 1 and 2, in operation S210, MAG1 performs an HoA test with MAG2 using an IPv6 HoA of the MN 110 and an IPv6 address of the CN 150 in order to optimize a route between the MN 110 and the CN 150. The MN 110 and the CN 150 support IPv6.

Specifically, MAG1 generates a Proxy HoTI message that includes the IPv6 HoA of the MN 110 and the IPv6 address of the CN 150 as a source address and a destination address, respectively.

For example, in the route optimization management message shown in FIG. 4, MAG1 may generate the Proxy HoTI message by inserting Proxy HoTI in a mobility header field 460, and inserting the IPv6 HoA of the MN 110 and the IPv6 address of the CN 150 in a source address field 410 and a destination address field 420 for a node that supports the IPv6 HoA.

In this instance, MAG1 may include the IPv4 HoA of the MN 110 and the IPv4 address of the CN 150 in the Proxy HoTI message using a mobility option such as IPv4 MN HAO and IPv4 Alt CN Address Option. As described above, the IPv4 MN HAP denotes an option to include a HoA of the MN 110 in the PMIPv6 message. The IPv4 Alt CN Address Option denotes an option to include an address of the CN 150 in the PMIPv6 message. Through this, MAG1 may perform the HoA test with MAG2 using the IPv4 HoA of the MN 110 and the IPv4 address of the CN 150.

In operation S310 of FIG. 3, MAG1 transmits the generated Proxy HoTI message to MAG2 via the LMA 130.

MAG2 receives the Proxy HoTI message. In response to the received Proxy HoTI message, MAG2 generates a Proxy HoT message that includes the IPv6 address of the CN 150 and the IPv6 HoA of the MN 110 as the source address and the destination address, respectively.

For example, in the route optimization management message shown in FIG. 5, MAG2 may generate the Proxy HoT message by inserting Proxy HoT in a mobility header field 560, and inserting the IPv6 address of the CN 150 and the IPv6 HoA of the MN 110 in a source address field 510 and a destination address field 520 for a node that supports the IPv6 HoA.

In this instance, MAG2 may include the IPv4 HoA of the MN 110 and the IPv4 address of the CN 150 in the Proxy HoT message using the mobility option such as the IPv4 MN HAO and the IPv4 Alt CN address Option. Through this, MAG2 may perform the HoA test with MAG1 using the IPv4 HoA of the MN 110 and the IPv4 address of the CN 150.

In operation S320, MAG2 transmits the generated Proxy HoT message to MAG1 via the LMA 130.

Also, in order to optimize the route between the MN 110 and the CN 150 that support IPv4, MAG1 may perform an HoA test with MAG2 using an IPv6 Proxy CoA of MAG1 and an IPv6 Proxy CoA of MAG2.

Specifically, MAG1 generates a Proxy HoTI message that includes the IPv6 Proxy CoA of MAG1 and the IPv6 Proxy CoA of MAG2 as a source address and a destination address, respectively.

For example, in the route optimization management message shown in FIG. 4, MAG1 may generate the Proxy HoTI message by inserting Proxy HoTI in the mobility header field 460 and inserting the IPv6 Proxy CoA of MAG1 and the IPv6 Proxy CoA of MAG2 in a source address field 430 and a destination address field 440, respectively.

In this instance, MAG1 may include the IPv4 HoA of the MN 110 and the IPv4 address of the CN 150 in the Proxy HoTI message by inserting the IPv4 MN HAO and the IPv4 Alt CN Address Option in a mobility options field 470.

In operation S310, MAG1 transmits the generated Proxy HoTI message to MAG2 via the LMA 130. In this instance, MAG1 may encapsulate the Proxy HoTI message, which is an IPv6 packet, using an IPv4 packet and transmit the encapsulated Proxy HoTI message to MAG2 via the LMA 130.

For example, as shown in FIG. 4, MAG1 may insert the IPv4 HoA of the MN and the IPv4 address of the CN 150 in a field 450 of the Proxy HoTI message, to respectively correspond to the IPv6 Proxy CoA of MAG1 in the source destination field 430 and the IPv6 Proxy CoA of MAG2 in the destination address field 440. Through this, MAG1 may encapsulate the Proxy HoTI message, which is the IPv6 packet, using the IPv4 packet.

MAG2 receives the Proxy HoTI message. In response to the received Proxy HoTI message, MAG2 generates a Proxy HoT message that includes the IPv6 Proxy CoA of MAG2 and the IPv6 Proxy CoA of MAG1 as the source address and the destination address, respectively. In this instance, MAG2 may include the IPv4 HoA of the MN 110 and the IPv4 address of the CN 150 using the mobility option such as the IPv4 MN HAO and the IPv4 Alt CN Address Option.

For example, in the route optimization management message shown in FIG. 5, MAG2 may insert Proxy HoT in the mobility header field 560. Also, MAG2 may include the IPv4 HoA of the MN 110 and the IPv4 address of the CN 150 in the Proxy HoTI message by inserting the IPv4 MN HAO and the IPv4 Alt CN Address Option in a mobility options field 570. Also, MAG2 may generate the Proxy HoT message by inserting the IPv6 Proxy CoA of MAG2 and the IPv6 Proxy CoA of MAG1 in the source address field 530 and the destination address field 540, respectively.

In operation S320, MAG2 transmits the generated Proxy HoT message to MAG1 via the LMA 130. In this instance, MAG2 may encapsulate the Proxy HoT message, which is the IPv6 packet, using the IPv4 packet and transmit the encapsulated Proxy HoT message to MAG1 via the LMA 130.

For example, as shown in FIG. 5, MAG2 may insert the IPv4 address of the CN 150 and the IPv4 HoA of the MN 110 in a field 550 of the Proxy HoTI message, to respectively correspond to the IPv6 Proxy CoA of MAG2 in the source address field 530 and the IPv6 Proxy CoA of MAG1 in the destination address field 540. Through this, MAG2 may encapsulate the Proxy HoT message, which is the IPv6 packet, using the IPv4 packet.

According to another exemplary embodiment of the present invention, MAG1 may perform a HoA test with MAG2 using the IPv4 Proxy CoA of MAG1 and IPv4 Proxy CoA of MAG2 in order to optimize a route between nodes, that is, between the MN 110 and the CN 150 that support IPv6. Specifically, MAG1 and MAG2 may perform the HoA test using the IPv4 Proxy CoA of MAG1 and the IPv4 Proxy CoA of MAG2 with respect to the IPv6 HoA of the MN 110 and the IPv6 HoA of the CN 150.

According to still another exemplary embodiment of the presetninvetnion, MAG1 may perform a HoA test with MAG2 using the IPv4 Proxy CoA of MAG1 and the IPv4 Proxy CoA of MAG2 in order to optimize the route between the nodes, that is, between the MN 110 and the CN 150 that support IPv4. Specifically, MAG1 and MAG2 may perform the HoA using the IPv4 Proxy CoA of MAG1 and the IPv4 Proxy CoA of MAG2 with respect to the IPv4 HoA of the MN 110 and the IPv4 HoA of the CN 150.

In operation S220, MAG1 performs a CoA test using the IPv6 Proxy CoA of MAG1 and the IPv6 address of the CN 150 in order to optimize the route between the MN 110 and the CN 150 that support IPv6. The CoA test is used to test a direct connectivity between MAG1 and MAG2.

Specifically, MAG1 generates a Proxy CoTI message that includes the IPv6 Proxy CoA of MAG1 and the IPv6 address of the CN 150 as the source address and the destination address, respectively.

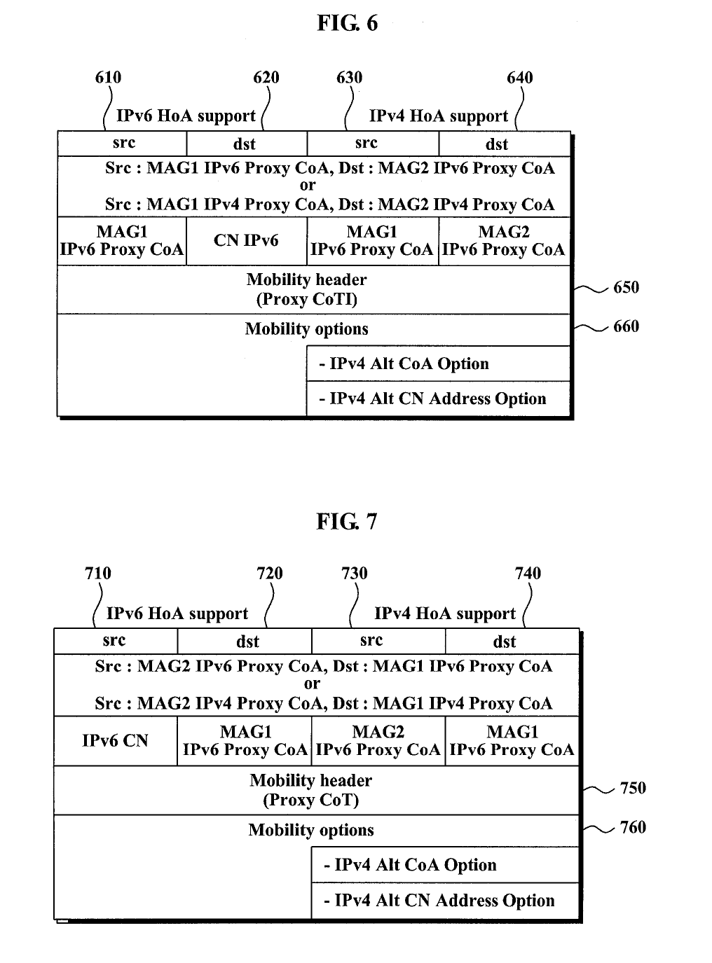

For example, in the route optimization management message shown in FIG. 6, MAG1 may generate the Proxy CoTI message by inserting Proxy CoTI in a mobility header field 650, and inserting the IPv6 Proxy CoA of MAG1 and the IPv6 address of the CN 150 in a source address field 610 and a destination address field 620 for a node that supports the IPv6 HoA.

In operation S330, MAG1 directly transmits the generated Proxy CoTI message to MAG2. For this, MAG1 encapsulates the Proxy CoTI message using an IPv4 packet or an IPv6 packet. In this instance, the source address field 610 of the encapsulated packet may correspond to the IPv4 Proxy CoA or the IPv6 Proxy CoA of MAG1. The destination address field 620 of the encapsulated packet may correspond to the IPv4 Proxy CoA or the IPv6 Proxy CoA of MAG2.

MAG2 receives the Proxy CoTI message. In response to the received Proxy CoTI message, MAG2 generates a Proxy CoT message that includes the IPv6 address of the CN 150 and the IPv6 Proxy CoA of MAG1 as the source address and the destination address, respectively.

For example, as the route optimization management message shown in FIG. 7, MAG2 may generate the Proxy CoT message by inserting Proxy CoT in a mobility header field 750, and inserting the IPv6 address of the CN 150 and the IPv6 Proxy CoA of MAG1 in a source address field 710 and a destination address field 720 for a node that supports the IPv6 HoA.

In operation S340, MAG2 directly transmits the generated Proxy CoT message to MAG1. For this, MAG2 encapsulates the Proxy CoT message using an IPv4 packet or an IPv6 packet and transmits the encapsulated Proxy CoT message. In this instance, the source address field 610 of the encapsulated packet may correspond to the IPv4 Proxy CoA or the IPv6 Proxy CoA of MAG2. The destination address field 620 may correspond to the IPv4 Proxy CoA or the IPv6 Proxy CoA of MAG1.

According to an aspect of the present invention, operations S210 and S220 may be simultaneously performed. Specifically, the HoA test and the CoA test may be simultaneously performed.

Also, in order to optimize the route between the MN 110 and the CN 150 that support IPv4, MAG1 may perform the CoA test using the IPv6 Proxy CoA of MAG1 and the IPv6 Proxy CoA of MAG2. In this instance, the CoA test is used to test a direct connectivity between MAG1 and MAG2.

Specifically, MAG1 generates a Proxy CoTI message that includes the IPv6 Proxy CoA of MAG1 and the IPv6 Proxy CoA of MAG2 as the source address and the destination address, respectively. For this, MAG1 may include the IPv4 Proxy CoA of MAG1 and the IPv4 address of the CN 150 in the Proxy CoTI message using the mobility option such as the IPv4 Alt CoA Option and the IPv4 Alt CN Address Option.

For example, in the route optimization management message shown in FIG. 6, MAG1 may insert Proxy CoTI in the mobility header field 650, insert the IPv4 Alt CoA Option and the IPv4 Alt CN Address Option in a mobility options field 660, and insert the IPv6 Proxy CoA of MAG1 and the IPv6 Proxy CoA of MAG2 in a source address field 630 and a destination address field 640 for the node that supports the IPv4 HoA. MAG1 may include the IPv4 Proxy CoA of MAG1 and the IPv4 address of the CN 150 in the Proxy CoTI message.

In operation S330, MAG1 directly transmits the generated Proxy CoTI message to MAG2. MAG1 may encapsulate the Proxy CoTI message, which is an IPv6 packet, using an IPv4 packet and transmit the encapsulated Proxy CoTI message to MAG2.

MAG2 receives the Proxy CoTI message. In response to the received Proxy CoTI message, MAG2 generates a Proxy CoT message that includes the IPv6 Proxy CoA of MAG2 and the IPv6 Proxy CoA of MAG1 as the source address and the destination address, respectively. For this, MAG2 may include the IPv4 Proxy CoA of MAG2 and the IPv4 address of the MN 110 in the Proxy CoT message using the mobility option such as the IPv4 Alt CoA Option and the IPv4 Alt CN Address Option.

For example, in the route optimization management message shown in FIG. 7, MAG2 may insert a Proxy CoT in the mobility header field 750, insert the IPv4 Alt CoA Option and the IPv4 Alt CN Address Option in the mobility options field 760, and insert the IPv6 Proxy CoA of MAG2 and the IPv6 Proxy CoA of MAG1 in the source address field 730 and the destination address field 740 for the node that supports the IPv4 HoA. MAG2 may include the IPv4 Proxy CoA of MAG2 and the IPv4 address of the MN 110 in the Proxy CoTI message.

In operation S340, MAG2 directly transmits the Proxy CoT message to MAG1. In this instance, MAG2 may encapsulate the Proxy CoT message, which is the IPv6 packet, using the IPv4 packet, and transmit the encapsulated Proxy CoT message to MAG1.

According to another exemplary embodiment of the present invention, MAG1 may perform a CoA test with MAG2 using the IPv4 Proxy CoA of MAG1 and the IPv4 Proxy CoA of MAG2 in order to optimize the route between the MN 110 and the CN 150 that support IPv6. The CoA test is used to test a direct connective between MAG1 and MAG2. Specifically, MAG1 and MAG2 may perform the CoA test using the IPv4 Proxy CoA of MAG1 and the IPv4 Proxy CoA of MAG2 with respect to the IPv6 HoA of the MN 110 and the IPv6 HoA of the CN 150.

According to still another exemplary embodiment, MAG1 may perform the CoA test with MAG2 using the IPv4 Proxy CoA of MAG1 and the IPv4 Proxy CoA of MAG2 in order to optimize the route between the MN 110 and the CN 150 that support IPv4. The CoA test is used to test a direct connective between MAG1 and MAG2. Specifically, MAG1 and MAG2 may perform the CoA test using the IPv4 Proxy CoA of MAG1 and the IPv4 Proxy CoA of MAG2 with respect to the IPv4 HoA of the MN 110 and the IPv4 HoA of the CN 150.

When the HoA test and the CoA test are normally implemented, that is, the “Yes” route in operation S230, MAG1 and MAG2 maintain binding information for optimizing the route between the MN 110 and the CN 150 that support IPv6 in operation S240. The binding information includes the IPv6 HoA of the MN 110, the IPv6 Proxy CoA of MAG1, and the IPv6 address of the CN 150.

Specifically, MAG1 updates the binding information by mapping the IPv6 Proxy CoA of MAG1 and the IPv6 HoA of the MN 110 with the IPv6 address of the CN 150. Also, MAG2 updates the binding information by mapping the IPv6 address of the CN 150 with the IPv6 Proxy CoA of MAG1 and the IPv6 HoA of the MN 110. In operation S240, MAG1 and MAG2 maintain the updated binding information during a predetermined period of time.

When the predetermined period of time elapses, MAG1 and MAG2 may delete the binding information. Also, when a binding update message is received within the predetermined period of time, MAG1 and MAG2 may again update the binding information.

Also, when the HoA test and the CoA test are normally completed, that is, the “Yes” route in operation S230, MAG1 and MAG2 may maintain binding information for optimizing the route between the MN 110 and the CN 150 that support IPv4 in operation S240. The binding information includes the IPv6 Proxy CoA of MAG1 and the IPv6 Proxy CoA of MAG2.

Specifically, MAG1 may update the binding information by mapping the IPv6 Proxy CoA of MAG1 and the IPv6 Proxy CoA of MAG2. Also, MAG2 may update the binding information by mapping the IPv6 Proxy CoA of MAG2 and the IPv6 Proxy CoA of MAG1. In operation S240, MAG1 and MAG2 may maintain the updated binding information during a predetermined period of time.

According to another exemplary embodiment of the present invention, when the HoA test and the CoA test are normally completed, that is, the “Yes” route in operation S230, MAG1 and MAG2 may maintain binding information for optimizing the route between the MN 110 and the CN 150 that support IPv6 in operation S240. The binding information includes the IPv4 Proxy CoA of MAG1 and the IPv4 Proxy CoA of MAG2.

Specifically, MAG1 may update the binding information by mapping the IPv4 Proxy CoA of MAG1 and the IPv4 Proxy CoA of MAG2. Also, MAG2 may update the binding information by mapping the IPv4 Proxy CoA of MAG2 and the IPv4 Proxy CoA of MAG1.

According to still another exemplary embodiment of the present invention, when the HoA test and the CoA test are normally completed, that is, the “Yes” route in operation 5230, MAG1 and MAG2 may maintain binding information for optimizing the route between the MN 110 and the CN 150 that support IPv4 in operation S240. The binding information includes the IPv4 Proxy CoA of MAG1 and the IPv4 Proxy CoA of MAG2.

Specifically, MAG1 may update the binding information by mapping the IPv4 Proxy CoA of MAG1 and the IPv4 Proxy CoA of MAG2. Also, MAG2 may update the binding information by mapping the IPv4 Proxy CoA of MAG2 and the IPv4 Proxy CoA of MAG1 .

In operation S250, MAG1 and MAG2 may form a tunnel between MAG1 and MAG2 based on the binding information. Therefore, the MN 110 and the CN 150 exchange data using the tunnel. Specifically, in the PMIPv6 network 160 that includes at least one of IPv4 network and IPv6 network, the MN 110 and the CN 150 that support at least one of IPv4 and IPv6 may exchange data using the optimal route 180.

As described, according to an aspect of the preset invention, when data communication is performed between nodes, a method of optimizing a route between the nodes in a PMIPv6 network may use an optimal route formed between a first MAG and a second MAG without passing through an LMA. Therefore, it is possible to improve data communication efficiency between the nodes. Also, according to an aspect of the present invention, the method may prevent a great amount of data from concentrating on a single LMA due to enlargement of the PMIPv6 network. Therefore, it is possible to improve QoS of data and reduce data transmission latency.

Conversely, when the HoA test and the CoA are abnormally completed, that is, the “No” route in operation S230, MAG1 and MAG2 may perform operation 5210 and S220. In this case, MAG1 and MAG2 may repeat operation S210 and S220 a predetermined number of times.

According to another exemplary embodiment of the present invention, MAG1 and MAG2 may optimize a route between nodes, that is, between the MN 110 and the CN 150 using the IPv4/IPv6 Proxy CoA with respect to IPv4/IPv6 HoA of the MN 110 and IPv4/IPv6 HoA of the CN 150. Specifically, according to another exemplary embodiment of the present invention, it is possible to optimize the route between the nodes, that is, between the MN 110 and the CN 150 by a total of four combinations of IPv6 Proxy CoA/IPv4 Proxy CoA of MAG1 and IPv6 Proxy CoA/IPv4 Proxy CoA of MAG2 with respect to IPv6 HoA/IPv4 HoA of the MN 110 and IPv6 HoA/IPv4 HoA of the CN 150.

Specifically, according to another exemplary embodiment of the present invention, it is possible to perform a HoA test between MAG1 and MAG2 using the IPv6 HoA of the MN 110 and the IPv6 HoA of the CN 150, perform a CoA test between MAG1 and MAG2 using the IPv6 Proxy CoA of MAG1 and the IPv6 Proxy CoA of MAG2, and set an optimal route between MAG1 and MAG2 based on binding information that is generated by performing the HoA test and the CoA test.

According to still another exemplary embodiment of the present invention, it is possible to perform a HoA test between MAG1 and MAG2 using the IPv6 HoA of the MN 110 and the IPv6 HoA of the CN 150, perform a CoA test between MAG1 and MAG2 using the IPv4 Proxy CoA of MAG1 and the IPv4 Proxy CoA of MAG2, and set an optimal route between MAG1 and MAG2 based on binding information that is generated by performing the HoA test and the CoA test.

According to yet another exemplary embodiment of the present invention, it is possible to perform a HoA test between MAG1 and MAG2 using the IPv4 HoA of the MN 110 and the IPv4 HoA of the CN 150, perform a CoA test between MAG1 and MAG2 using the IPv6 Proxy CoA of MAG1 and the IPv6 Proxy CoA of MAG2, and set an optimal route between MAG1 and MAG2 based on binding information that is generated by performing the HoA test and the CoA test.

According to a further another exemplary embodiment of the present invention, it is possible to perform a HoA test between MAG1 and MAG2 using the IPv4 HoA of the MN 110 and the IPv4 HoA of the CN 150, perform a CoA test between MAG1 and MAG2 using the IPv4 Proxy CoA of MAG1 and the IPv4 Proxy CoA of MAG2, and set an optimal route between MAG1 and MAG2 based on binding information that is generated by performing the HoA test and the CoA test.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

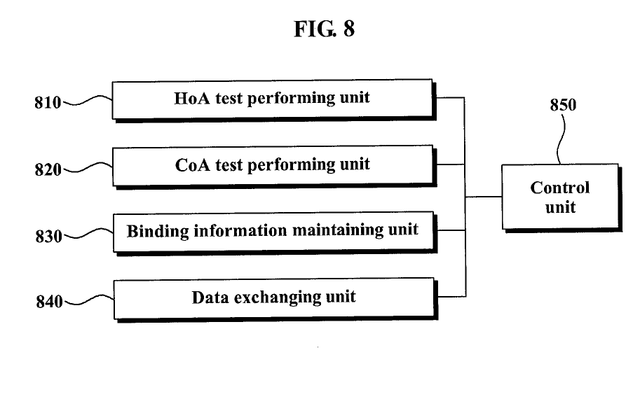

FIG. 8 is a block diagram illustrating a system for optimizing a route between nodes in a PMIPv6 network according to an exemplary embodiment of the present invention.

Referring to FIGS. 1 and 8, the system includes an HoA test performing unit 810, a CoA test performing unit 820, a binding information maintaining unit 830, a data exchanging unit 840, and a control unit 850.

The HoA test performing unit 810 performs the HoA test between MAG1 and MAG2 using the IPv6 HoA of the MN 110 and the IPv6 address of the CN 150 in order to optimize the route between the MN 110 and the CN 150 that support IPv6.

Specifically, the HoA test performing unit 810 may be provided in each of MAG1 and MAG2. MAG1 generates the Proxy HoTI message that includes the IPv6 HoA of the MN 110 and the IPv6 address of the CN 150 as the source address and the destination address, respectively.

MAG1 transmits the Proxy HoTI message to MAG2 via the LMA 130.

MAG2 receives the Proxy HoTI message. In response to the received Proxy HoTI message, MAG2 generates the Proxy HoT message that includes the IPv6 address of the CN 150 and the IPv6 HoA of the MN 110 as the source address and the destination address, respectively. MAG2 transmits the generated Proxy HoT message to MAG1 via the LMA 130.

Also, in order to optimize the route between the MN 110 and the CN 150 that support IPv4, the HoA test performing unit 810 may perform the HoA test between MAG1 and MAG2 using the IPv4 HoA of the MN 110 and the IPv4 address of the CN 150.

Specifically, MAG1 generates the Proxy HoTI message that includes the IPv6 Proxy CoA of MAG1 and the IPv6 Proxy CoA of MAG2 as the source address and the destination address, respectively. For this, MAG1 may include the IPv4 HoA of the MN 110 and the IPv4 address of the CN 150 in the Proxy HoTI message using the mobility option such as the IPv4 MN HAO and the IPv4 Alt CN Address Option.

MAG1 transmits the generated Proxy HoTI message to MAG2 via the LMA 130. In this instance, MAG1 may encapsulate the Proxy HoTI message, which is the IPv6 packet, using the IPv4 packet and transmit the encapsulated Proxy HoTI message to MAG2 via the LMA 130.

MAG2 receives the Proxy HoTI message. In response to the received Proxy HoTI message, MAG2 generates the Proxy HoT message that includes the IPv6 Proxy CoA of MAG2 and the IPv6 Proxy CoA of MAG1 as the source address and the destination address, respectively. For this, MAG2 may include the IPv4 HoA of the MN 110 and the IPv4 address of the CN 150 in the Proxy HoT message using the mobility option such as the IPv4 MN HAO and the IPv4 Alt CN Address Option.

MAG2 transmits the generated Proxy HoT message to MAG1 via the LMA 130. In this instance, MAG2 may encapsulate the Proxy HoT message, which is the IPv6 packet, using the IPv4 packet, and transmit the encapsulated Proxy HoT message.

In order to optimize the route between the MN 110 and the CN 150 that support IPv6, the CoA performing unit 820 performs the CoA test using the IPv4 Proxy CoA of MAG1 and the IPv6 address of the CN 150. The CoA test is used to test a direct connectivity between MAG1 and MAG2.

Specifically, the CoA test performing unit 820 may be provided in each of MAG1 and MAG2. MAG1 generates the Proxy CoTI message that includes the IPv6 Proxy CoA of MAG1 and the IPv6 address of the CN 150 as the source address and the destination address, respectively.

For this, MAG1 may include the IPv6 Proxy CoA of MAG1 and the IPv6 address of the CN 150 in the Proxy CoTI message using the mobility option such as the IPv4 Alt CoA Option and the IPv4 Alt CN Address Option.

MAG1 directly transmits the generated Proxy CoTI message to MAG2.

MAG2 receives the Proxy CoTI message. In response to the received Proxy CoTI message, MAG2 generates the Proxy CoT message that includes the IPv6 address of the CN 150 and the IPv6 Proxy CoA of MAG1 as the source address and the destination address, respectively.

For this, MAG2 may include the IPv6 Proxy CoA of MAG1 and the IPv6 address of the CN 150 in the Proxy CoT message, using the mobility option such as the IPv4 Alt CoA Option and the IPv4 Alt CN Address Option.

MAG2 directly transmits the generated Proxy CoT message to MAG1.

According to an aspect of the present invention, the HoA test performing unit 810 and the CoA test performing unit 820 may simultaneously operate to perform the HoA test and the CoA test at the same time.

Also, in order to optimize the route between the MN 110 and the CN 150 that support IPv4, the CoA test performing unit 820 MAG1 may perform the CoA test using the IPv4 Proxy CoA of MAG1 and the IPv4 address of the CN 150. In this instance, the CoA test is used to test a direct connectivity between MAG1 and MAG2.

Specifically, MAG1 may generate the Proxy CoTI message that includes the IPv6 Proxy CoA of MAG1 and the IPv6 Proxy CoA of MAG2 as the source address and the destination address, respectively. For this, MAG1 may include the IPv4 Proxy CoA of MAG1 and the IPv4 address of the CN 150 in the Proxy CoTI message using the mobility option such as the IPv4 Alt CoA Option and the IPv4 Alt CN Address Option.

MAG1 may directly transmit the generated Proxy CoTI message to MAG2. In this instance, MAG1 may encapsulate the Proxy CoTI message, which is the IPv6 packet, using the IPv4 packet and transmit the encapsulated Proxy CoTI message to MAG2.

MAG2 receives the Proxy CoTI message. In response to the received Proxy CoTI message, MAG2 generates the Proxy CoT message that includes the IPv6 Proxy CoA of MAG2 and the IPv6 Proxy CoA of MAG1 as the source address and the destination address, respectively.

For this, MAG2 may include the IPv4 Proxy CoA of MAG1 and the IPv4 address of the CN 150 in the Proxy CoT message using the mobility option such as the IPv4 Alt CoA Option and the IPv4 Alt CN Address Option.

MAG2 may directly transmit the Proxy CoT message to MAG1. In this instance, MAG2 may encapsulate the Proxy CoT message, which is the IPv6 packet, using the IPv4 packet, and transmit the encapsulated Proxy CoT message to MAG1.

When the HoA test and the CoA test are normally implemented, the binding information maintaining unit 830 maintains binding information between MAG1 and MAG2 in order to optimize the route between the MN 110 and the CN 150 that support IPv6. The binding information includes the IPv6 HoA of the MN 110, the IPv6 Proxy CoA of MAG1, and the IPv6 address of the CN 150.

Specifically, the binding information maintaining unit 830 may be provided in each of MAG1 and MAG2. MAG1 updates the binding information by mapping the IPv6 Proxy CoA of MAG1 and the IPv6 HoA of the MN 110 with the IPv6 address of the CN 150.

Also, MAG2 updates the binding information by mapping the IPv6 address of the CN 150 with the IPv6 Proxy CoA of MAG1 and the IPv6 HoA of the MN 110.

MAG1 and MAG2 maintain the updated binding information during a predetermined period of time. When the predetermined period of time elapses, MAG1 and MAG2 may delete the binding information. Also, when a binding update message is received within the predetermined period of time, MAG1 and MAG2 may again update the binding information.

Also, when the HoA test and the CoA test are normally completed, the binding information maintaining unit 830 may maintain binding information in order to optimize the route between the MN 110 and the CN 150 that support IPv4. The binding information includes the IPv4 Proxy CoA of MAG1 and the IPv4 Proxy CoA of MAG2.

Specifically, MAG1 may update the binding information by mapping the IPv4 Proxy CoA of MAG1 and the IPv4 Proxy CoA of MAG2.

Also, MAG2 may update the binding information by mapping the IPv4 Proxy CoA of MAG1 and the IPv4 Proxy CoA of MAG2.

MAG1 and MAG 2 may maintain the updated binding information during a predetermined period of time.

The data exchanging unit 840 forms a tunnel between MAG1 and MAG2 based on the binding information. Therefore, the data exchanging unit 840 enables the MN 110 and the CN 150 to exchange data using the tunnel. Specifically, in the PMIPv6 network 160 that includes at least one of an IPv4 network and an IPv6 network, the data exchanging unit enables the MN 110 and the CN 150 that support at least one of IPv4 and IPv6 to exchange data using the optimal route 180. The data exchanging unit 840 may be provided in each of MAG1 and MAG2.

As described above, according to an aspect of the present invention, when data communication is performed between nodes, a system for optimizing a route between the nodes in a PMIPv6 network may use an optimal route formed between a first MAG and a second MAG without passing through an LMA. Therefore, it is possible to improve data communication efficiency between the nodes. Also, according to an aspect of the present invention, the system may prevent a great amount of data from concentrating on a single LMA due to enlargement of the PMIPv6 network. Therefore, it is possible to improve QoS of data and reduce data transmission latency.

The control unit 850 functions to control the system for optimizing the route between nodes in the PMIPv6 network 160. Specifically, the control unit 850 may control the HoA test performing unit 810, the CoA test performing unit 820, the binding information maintaining unit 830, the data exchanging unit 840, and the like. The control unit 850 may be provided in each of MAG1 that is the first MAG 120 and MAG2 that is the second MAG 140.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of optimizing a route between nodes in a Proxy Mobile Internet Protocol version 6 (PMIPv6) network, the method comprising:
performing a home address (HoA) test between a first Mobile Access Gateway (MAG) and a second MAG using an Internet Protocol version 6 (IPv6) home address of a mobile node and an IPv6 address of a correspondent node;
performing a care-of address (CoA) test between the first MAG and the second MAG using an IPv6 Proxy CoA of the first MAG and the IPv6 address of the correspondent node; and
setting an optimal route between the first MAG and the second MAG based on binding information that is generated by performing the HoA test and the CoA test.

2. The method of claim 1, wherein the performing of the HoA test comprises:
at the first MAG,
generating a Proxy Home Test Init (HoTI) message that includes the IPv6 home address of the mobile node and the IPv6 address of the correspondent node as a source address and a destination address, respectively; and
transmitting the generated Proxy HoTI message to the second MAG via a Local Mobility Anchor (LMA); and
at the second MAG,
receiving the Proxy Hal message;
generating a Proxy Home Test (HoT) message, in response to the received Proxy HoTI message, that includes the IPv6 address of the correspondent node and the IPv6 home address of the mobile node as the source address and the destination address, respectively; and
transmitting the generated Proxy HoT message to the first MAG via the LMA.

3. The method of claim 2, wherein the performing of the HoA test further comprises:
including, by the first MAG, an IPv4 home address of the mobile node and an IPv4 address of the correspondent node in the Proxy HoTI message using a predetermined mobility option; and
including, by the second MAG, the IPv4 home address of the mobile node and the IPv4 address of the correspondent node in the Proxy HoT message using the predetermined mobility option.

4. The method of claim 1, wherein the performing of the CoA test comprises:
at the first MAG,
generating a Proxy Care-of Test Init (CoTI) message that includes the IPv6 Proxy CoA of the first MAG and the IPv6 address of the correspondent node as a source address and a destination address, respectively; and
directly transmitting the generated Proxy CoTI message to the second MAG; and
at the second MAG,
receiving the Proxy CoTI message;
generating a Proxy Care-of Test (CoT) message, in response to the received Proxy CoTI message, that includes the IPv6 address of the correspondent node and the IPv6 Proxy CoA of the first MAG as the source address and the destination address, respectively; and
directly transmitting the generated Proxy CoT message to the first MAG.

5. The method of claim 4, wherein the performing of the CoA test further comprises:
including, by the first MAG, the IPv4 Proxy CoA of the first MAG and the IPv4 address of the correspondent node in the Proxy CoTI message using a predetermined mobility option; and
including, by the second MAG, the IPv4 Proxy CoA of the first MAG and the IPv4 address of the correspondent node in the Proxy CoT message using the predetermined mobility option.

6. The method of claim 1, wherein the binding information comprises the IPv6 home address of the mobile node, the IPv6 Proxy CoA of the first MAG, and the IPv6 address of the correspondent node, and the method further comprises:
maintaining the binding information between the mobile node and the correspondent node, when the HoA test and the CoA test are normally completed.

7. The method of claim 6, wherein the maintaining comprises:
updating, by the first MAG, the binding information by mapping the IPv6 Proxy CoA of the first MAG and the IPv6 home address of the mobile node with the IPv6 address of the correspondent node;
updating, by the second MAG, the binding information by mapping the IPv6 address of the correspondent node with the IPv6 Proxy CoA of the first MAG and the IPv6 home address of the mobile node; and
maintaining, by the first MAG and the second MAG, the updated binding information during a predetermined period of time.

8. A method of optimizing a route between nodes in a PMIPv6 network, the method comprising:
performing an HoA test between a first MAG and a second MAG using an IPv6 Proxy CoA of the first MAG and an IPv6 Proxy CoA of the second MAG;
performing a CoA test between the first MAG and the second MAG using the IPv6 Proxy CoA of the first MAG and the IPv6 Proxy CoA of the second MAG; and
setting an optimal route between the first MAG and the second MAG based on binding information that is generated by performing the HoA test and the CoA test.

9. The method of claim 8, wherein the performing of the HoA test comprises:
at the first MAG,
generating a Proxy HoTI message that includes the IPv6 Proxy CoA of the first MAG and the IPv6 Proxy CoA of the second MAG as a source address and a destination address, respectively; and
transmitting the generated Proxy HoTI message to the second MAG via an LMA; and
at the second MAG,
receiving the Proxy HoTI message;
generating a Proxy HoT message, in response to the received Proxy HoTI message, that includes the IPv6 Proxy CoA of the second MAG and the IPv6 Proxy CoA of the first MAG as the source address and the destination address, respectively; and
transmitting the generated Proxy HoT message to the first MAG via the LMA.

10. The method of claim 9, wherein the performing of the HoA test further comprises:
including, by the first MAG, an IPv4 home address of a mobile node and an IPv4 address of a correspondent node in the Proxy HoTI message using a predetermined motility option;
encapsulating, by the first MAG, the Proxy HoTI message;
including, by the second MAG, the IPv4 home address of the mobile node and the IPv4 address of the correspondent node in the Proxy HoT message using the predetermined motility option; and
encapsulating, by the second MAG, the Proxy HoT message.

11. The method of claim 8, wherein the performing of the CoA test comprises:
at the first MAG,
generating a Proxy CoTI message that includes the IPv6 Proxy CoA of the first MAG and the IPv6 Proxy CoA of the second MAG as a source address and a destination address, respectively; and
directly transmitting the generated Proxy CoTI message to the second MAG; and
at the second MAG,
receiving the Proxy CoTI message;
generating a Proxy CoT message, in response to the received Proxy CoTI message, that include the IPv6 Proxy CoA of the second MAG and the IPv6 Proxy CoA of the first MAG as the source address and the destination address, respectively; and
directly transmitting the generated Proxy CoT message to the first MAG.

12. The method of claim 11, wherein the performing of the CoA test further comprises:
including, by the first MAG, an IPv4 Proxy CoA of the first MAG and an IPv4 address of a correspondent node in the Proxy CoTI message using a predetermined motility option;
encapsulating, by the first MAG, the Proxy CoTI message;
including, by the second MAG, an IPv4 Proxy CoA of the second MAG and the IPv4 address of the correspondent node in the Proxy CoT message; and
encapsulating, by the second MAG, the Proxy CoT message.

13. The method of claim 8, wherein the binding information comprises the IPv6 Proxy CoA of the first MAG and the IPv6 Proxy CoA of the second MAG, and the method further comprises:
maintaining the binding information between the mobile node and the correspondent node, when the HoA test and the CoA test are normally completed.

14. A method of optimizing a route between nodes in a PMIPv6 network, the method comprising:
performing a HoA test between a first MAG and a second MAG using an IPv6 home address of a mobile node and an IPv6 home address of a correspondent node;
performing a CoA test between the first MAG and the second MAG using an IPv6 Proxy CoA of the first MAG and an IPv6 Proxy CoA of the second MAG; and
setting an optimal route between the first MAG and the second MAG based on binding information that is generated by performing the HoA test and the CoA test.

15. A method of optimizing a route between nodes in a PMIPv6 network, the method comprising:
performing a HoA test between a first MAG and a second MAG using an IPv6 home address of a mobile node and an IPv6 home address of a correspondent node;
performing a CoA test between the first MAG and the second MAG using an IPv4 Proxy CoA of the first MAG and an IPv4 Proxy CoA of the second MAG; and
setting an optimal route between the first MAG and the second MAG based on binding information that is generated by performing the HoA test and the CoA test.

16. A method of optimizing a route between nodes in a PMIPv6 network, the method comprising:
performing a HoA test between a first MAG and a second MAG using an IPv4 home address of a mobile node and an IPv4 home address of a correspondent node;
performing a CoA test between the first MAG and the second MAG using an IPv6 Proxy CoA of the first MAG and an IPv6 Proxy CoA of the second MAG; and
setting an optimal route between the first MAG and the second MAG based on binding information that is generated by performing the HoA test and the CoA test.

17. A method of optimizing a route between nodes in a PMIPv6 network, the method comprising:
performing a HoA test between a first MAG and a second MAG using an IPv4 home address of a mobile node and an IPv4 home address of a correspondent node;
performing a CoA test between the first MAG and the second MAG using an IPv4 Proxy CoA of the first MAG and an IPv4 Proxy CoA of the second MAG; and
setting an optimal route between the first MAG and the second MAG based on binding information that is generated by performing the HoA test and the CoA test.

18. A system for optimizing a route between nodes in a PMIPv6 network, the system comprising:
an HoA test performing unit to perform an HoA test between a first MAG and a second MAG;
a CoA test performing unit to perform a CoA test between the first MAG and the second MAG; and
a binding information maintaining unit to set an optimal route between the first MAG and the second MAG based on binding information that is generated by performing the HoA test and the CoA test,
wherein the HoA test performing unit performs the HoA test by using at least one of 1) an IPv6 home address of a mobile node and an IPv6 address of a correspondent node, and 2) an IPv6 Proxy CoA of the first MAG and an IPv6 Proxy CoA of the second MAG, and
the CoA test performing unit performs the CoA test by using at least one of 1) the IPv6 Proxy CoA of the first MAG and the IPv6 address of the correspondent node, and 2) the IPv6 Proxy CoA of the first MAG and the IPv6 Proxy CoA of the second MAG.

19-24. (canceled)
